(19) United States
(12) Patent Application Publication
(10) Pub. No.: US 2010/0035547 A1
(43) Pub. Date: Feb. 11, 2010

(54) Video transmission apparatus and switch control method of output destination by video transmission apparatus

(75) Inventors: Jun Miyauchi, Kanagawa (JP); Koichiro Nishimura, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/462,517

(22) Filed: Aug. 5, 2009

(30) Foreign Application Priority Data
Aug. 7, 2008 (JP) P2008-204740

(51) Int. Cl. H04N 5/268; H04B 7/005

(52) U.S. Cl. 455/41.2; 348/705; 348/E05.057

(57) ABSTRACT

The present invention provides a video transmission apparatus including an input terminal input with a video signal; an output terminal wire connected to a video device; a wireless communication unit for modulating the video signal through a predetermined wireless modulation method and wirelessly transmitting the modulated video signal; an output switch unit, connected with the input terminal, the output terminal, and the wireless transmission unit, for switching an output destination of the video signal input from the input terminal to the output terminal or the wireless transmission unit; and a switch controller for causing the output switch unit to switch the output destination of the video signal in response to a switch request when receiving the switch request of the output destination by the wireless communication unit.

### BACKGROUND OF THE INVENTION

1. Field of the Invention

The present invention relates to a video transmission apparatus, and a switch control method of output destination by the video transmission apparatus.

2. Description of the Related Art

In recent years, scenes where the lecturer presents the material to the listener using a personal computer (PC) at the conference and public speaking are often seen. In such case, a projector wire connected to the PC is often used. The lecturer connects the PC to a DVI (Digital Visual Interface) terminal arranged at the projector by way of a cable, and delivers the speech while operating the PC at the position where the cable can reach. In some cases, an assistant that operates the PC is arranged in addition to the lecturer. In this case, the lecturer delivers the speech near the screen on which the screen content of the PC is projected.

Thus, the projector has been used to project a video on a large screen and present information to a large number of people. However, the projector is recently being widely used in general households, and a usage style of viewing movies and the like on a large screen by the projector has appeared. The background for this includes the fact that a high performance projector can be acquired relatively inexpensively, and that an environment in which a high quality video can be easily reproduced in the household by digitalization of the content is organized.

In order to use the projector, the projector and the reproduction device are obviously connected with a cable. However, in the household, the reproduction device and the recordation and reproduction device are installed near the television receiver, and the like, and are mutually connected with a cable. Thus, it is very troublesome to detach the cable and reconnect to the projector, or to move the reproduction device and the like to the vicinity of the projector. A technique of wirelessly transmitting the video signal output by the reproduction device and the like to the projector is thus given attention. Japanese Patent Application National Publication No. 2007-511977 discloses a technique of wirelessly transmitting the HDMI (High Definition Multi-Media Interface) data.

### SUMMARY OF THE INVENTION

However, the user may not view the video using the projector regardless of the viewing content. That is, the reproduction device and the wireless transmission device may not be necessarily connected at all times. Normally, the user switches the television receiver etc. and the wireless transmission device according to the type of video to view, and the like. In this case, the user replaces the cable extending from the output terminal of the reproduction device and the like between the television receiver etc. and the wireless transmission device. That is, the replacing operation of the cable is performed even when the wireless transmission device is used. Thus, most users are still in an environment in which the convenience is low.

The present invention addresses the above-identified, and other issues associated with conventional methods and apparatuses, and it is desirable to provide a new and improved video transmission apparatus capable of mutually switching the output destination of the video signal in a wired or a wireless manner in a device for wirelessly transmitting the video signal, and a switch control method of the output destination by the video transmission apparatus. The information regarding the output destination of the video signal is exchanged between the transmitting source and the transmitting destination of the video signal, and the state of the transmitting source or the transmitting destination can be controlled according to such information.

In order to solve the above issue, according to an embodiment of the present invention, there is provided a video transmission apparatus including an input terminal input with a video signal; an output terminal wire connected to a video device; a wireless communication unit for modulating the video signal through a predetermined wireless modulation method and wirelessly transmitting the modulated video signal; an output switch unit, connected with the input terminal, the output terminal, and the wireless transmission unit, for switching an output destination of the video signal input from the input terminal to the output terminal or the wireless transmission unit; and a switch controller for causing the output switch unit to switch the output destination of the video signal in response to a switch request when receiving the switch request of the output destination by the wireless communication unit.

The video signal may be an HDMI (High-Definition Multimedia Interface) signal; the switch request may be a control signal different from a CEC (Consumer Electronics Control) command; and the switch controller may cause the output switch unit to switch the output destination of the video signal in response to the control signal.

The switch controller may control the output switch unit to switch the output destination of the video signal to the output terminal when power is turned OFF at the output destination of the video signal wirelessly transmitted by the wireless transmission unit or when the video signal input to the input terminal is changed to a non-input state.

The output switch unit may output the video signal to the output terminal or the wireless transmission unit without canceling HDCP (High-bandwidth Digital Content Protection) performed on the HDMI signal.

In order to solve the above issue, according to another embodiment of the present invention, there is provided a video transmission apparatus including an input terminal input with a video signal; an output terminal wire connected to a video device; a wireless transmission unit for modulating the video signal through a predetermined wireless modulation method and wirelessly transmitting the modulated video signal; an output switch unit, connected with the input terminal, the output terminal, and the wireless transmission unit, for switching an output destination of the video signal input from the input terminal to the output terminal or the wireless transmission unit; and a switch controller for causing the output switch unit to switch the output destination of the video signal and causing the wireless transmission unit to transmit a switch notification notifying the switching of the output destination.

In order to solve the above issue, according to another embodiment of the present invention, there is provided a switch control method of an output destination by a video transmission apparatus including, an input terminal input with a video signal, an output terminal wire connected to a video device, a wireless transmission unit for modulating the video signal through a predetermined wireless modulation method and wirelessly transmitting the modulated video signal, and an output switch unit, connected with the input terminal, the output terminal, and the wireless transmission unit, for switching an output destination of the video signal input from the input terminal to the output terminal or the wireless transmission unit; the method comprising the step of: causing the output switch unit to switch the output destination of the video signal in response to a switch request when receiving the switch request of the output destination by the wireless communication unit from a transmitting destination of the video signal.

In order to solve the above issue, according to another embodiment of the present invention, there is provided a switch control method of an output destination by a video transmission apparatus including, an input terminal input with a video signal, an output terminal wire connected to a video device, a wireless transmission unit for modulating the video signal through a predetermined wireless modulation method and wirelessly transmitting the modulated video signal, and an output switch unit, connected with the input terminal, the output terminal, and the wireless transmission unit, for switching an output destination of the video signal input from the input terminal to the output terminal or the wireless transmission unit, the method comprising the step of: causing the output switch unit to switch the output destination of the video signal and causing the wireless transmission unit to transmit a switch notification notifying the switching of the output destination.

In order to solve the above issue, according to another embodiment of the present invention, there is provided a program for causing a computer to realize the functions of the video transmission apparatus. There is also provided a computer readable recording medium recorded with the program.

As described above, according to the present invention, the output destination of the video signal can be mutually switched between wired and wireless. The information related to the output destination of the video signal can be exchanged between the transmitting source and the transmitting destination of the video signal, and the state of the transmitting source or the transmitting destination can be controlled according to such information.

### BRIEF DESCRIPTION OF THE DRAWINGS

FIG. 1 shows one configuration example of a video output system;

FIG. 2 shows a configuration example of a video output system according to one embodiment of the present invention;

FIG. 3 shows a function configuration example of a wireless transmission device according to the embodiment;

FIG. 4 shows a function configuration example of a wireless transmission device according to the embodiment;

FIG. 5 shows an example of an automatic switch sequence of an output destination according to the embodiment;

FIG. 6 shows an example of an automatic switch sequence of an output destination according to the embodiment;

FIG. 7 shows an example of an automatic switch sequence of an output destination according to the embodiment;

FIG. 8 shows an example of an automatic switch sequence of an output destination according to the embodiment;

FIG. 9 shows an example of an automatic switch sequence of an output destination according to the embodiment;

FIG. 10 is a view for describing a switch control method according to the embodiment;

FIG. 11 is a view showing a configuration of a switch according to one variant of the embodiment;

FIG. 12 is a view showing a configuration of a switch according to one variant of the embodiment; and

FIG. 13 is a view showing a configuration of a switch according to one variant of the embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### [Regarding Flow of Description]

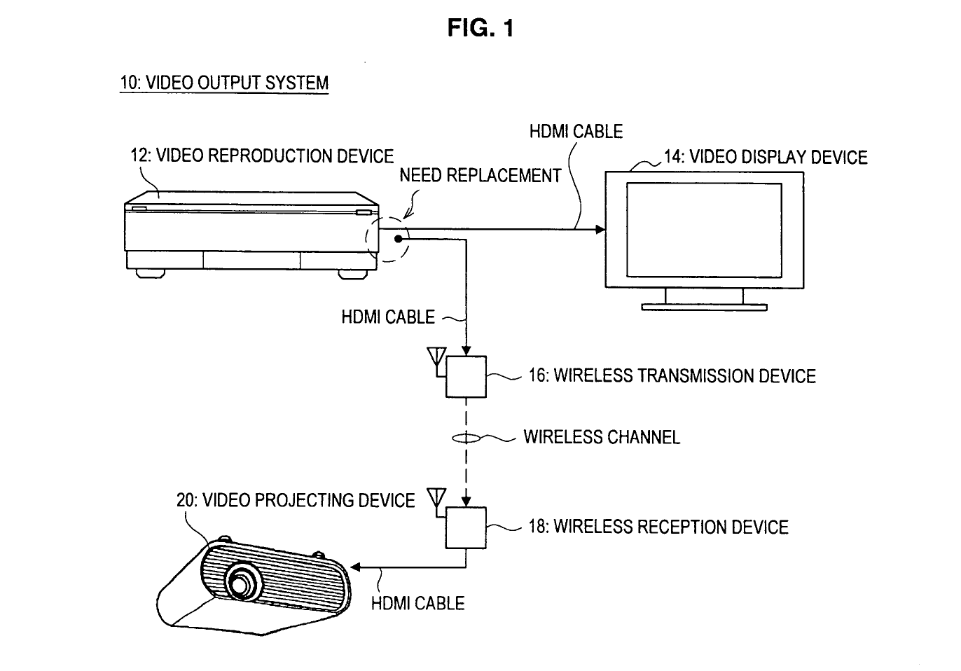

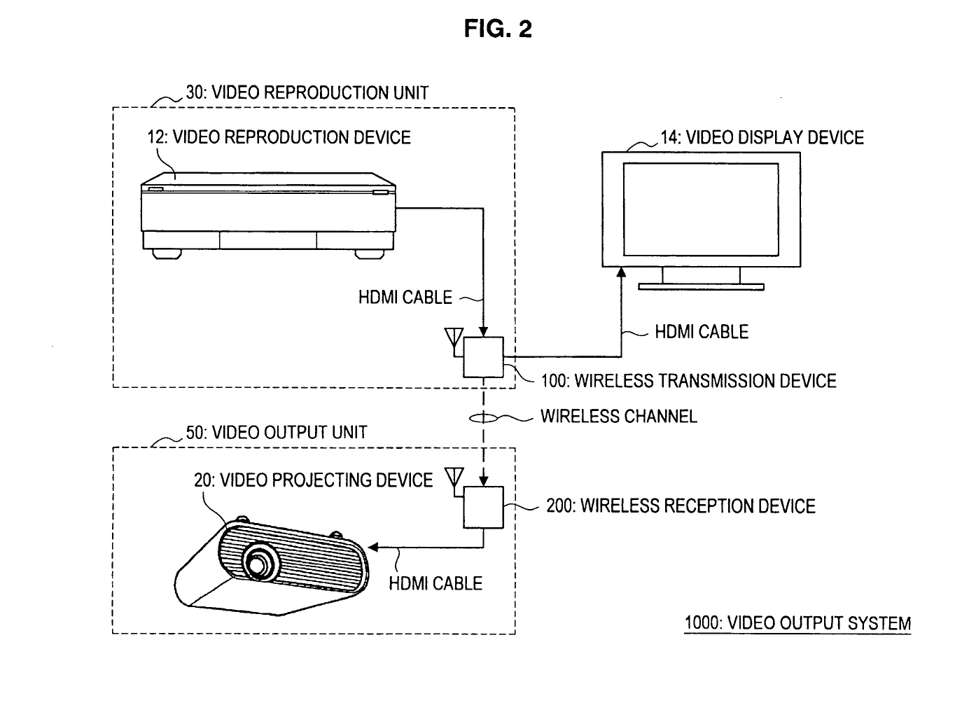

The flow of description about the embodiment according to the present invention will be briefly described below. First, one configuration example of a video output system will be described with reference to FIG. 1 to describe the technical issue of the relevant video output system. One configuration example of a video output system according to one embodiment of the present invention will then be described with reference to FIG. 2.

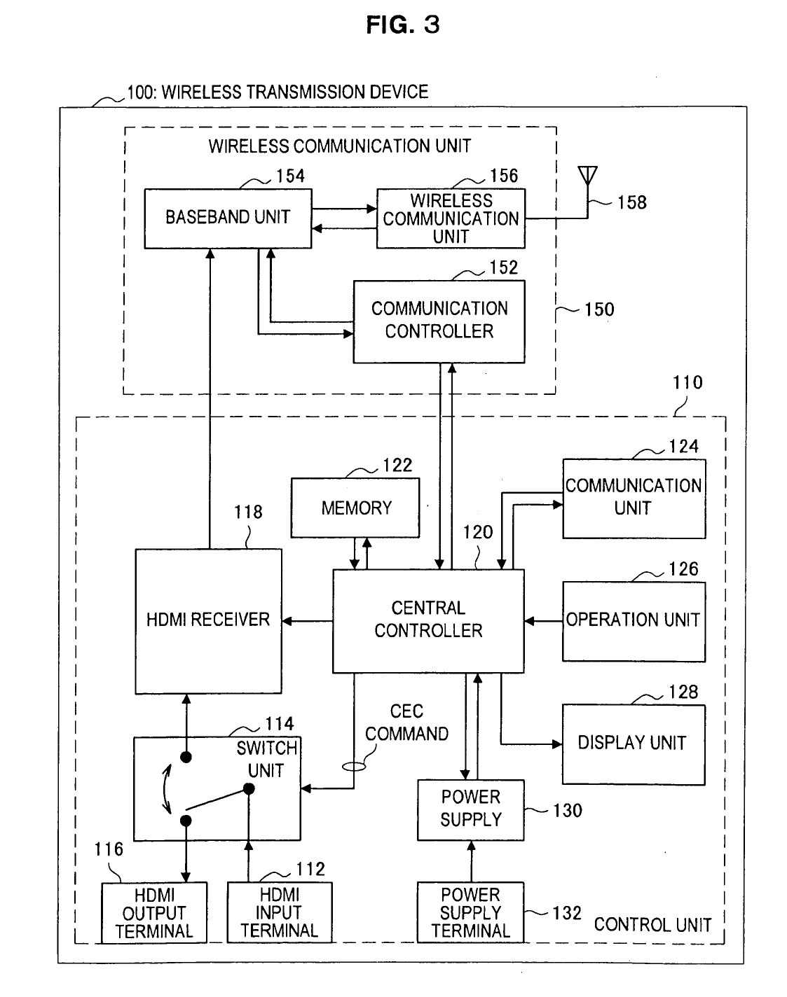

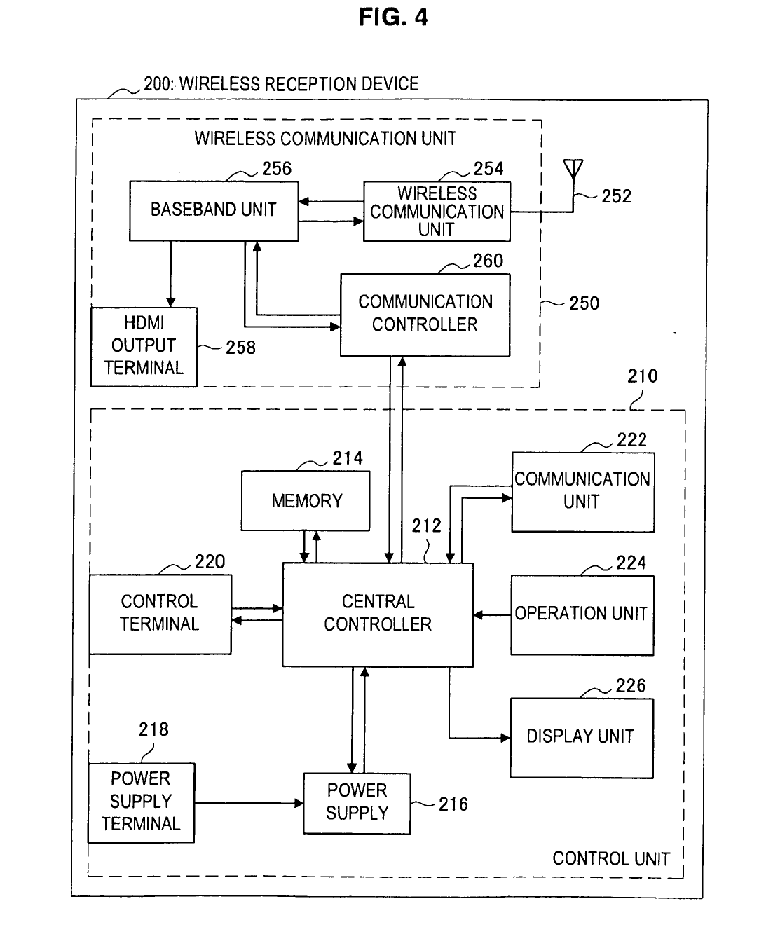

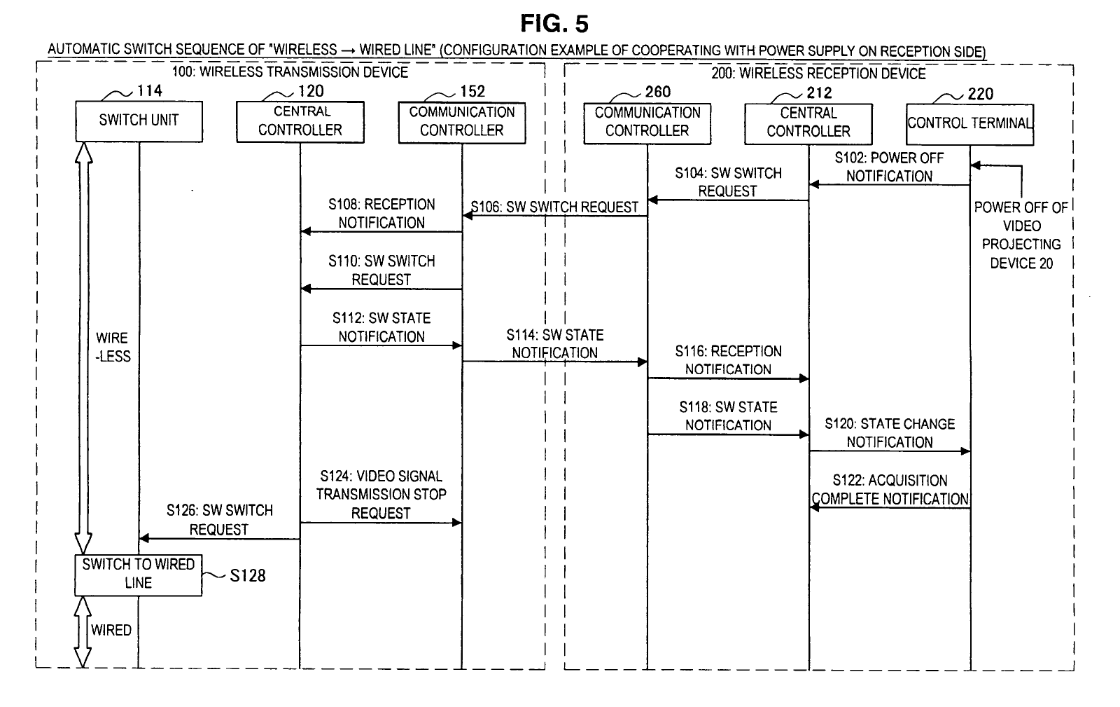

Then, the function configuration of a wireless transmission device included in the video output system of the embodiment will be described with reference to FIG. 3. The function configuration of a wireless reception device included in the video output system of the embodiment will then be described with reference to FIG. 4. The output destination automatic switch method of the video signal in the video output system of the embodiment will be specifically described using specific examples with reference to FIGS. 5 to 9.

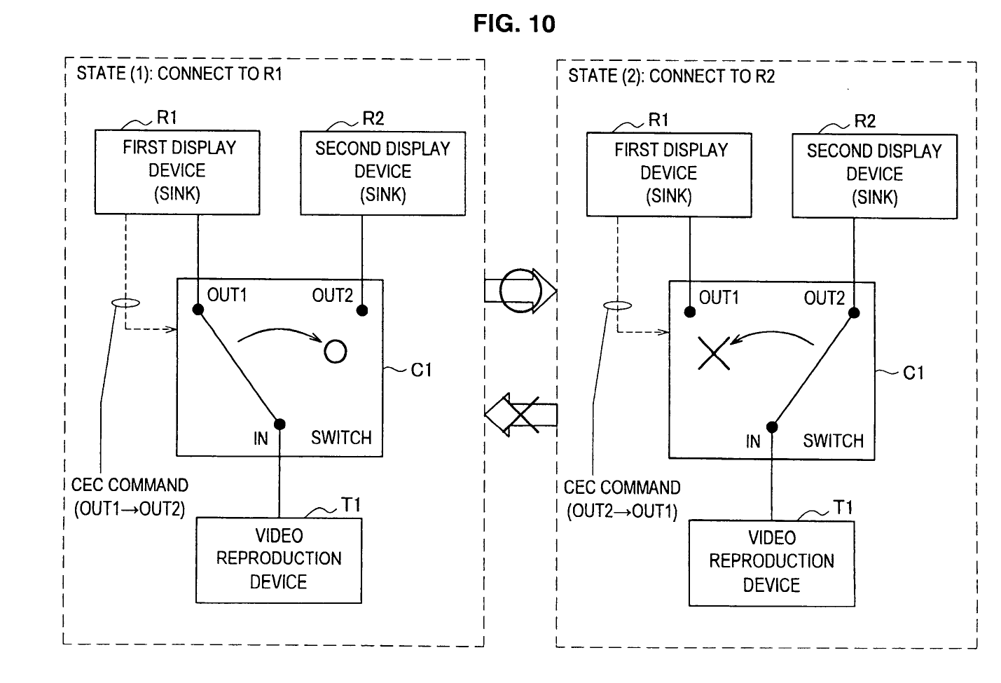

The technical issue in a switch control method using a CEC (Consumer Electronics Control) command will be pointed out with reference to FIG. 10. Furthermore, the means for solving such technical issue will be described. A variant according to the embodiment will be described with reference to FIGS. 11 to 13. Lastly, the technical idea of the embodiment will be summarized, and the effects obtained from the technical idea will be briefly described.

### [Organization of Issues]

First, prior to describing one embodiment of the present invention in detail, the issues to be solved by the present embodiment will be briefly summarized. First, a video output system 10 capable of realizing wireless transmission of the video signal will be described with reference to FIG. 1. In the description, the technical issue of the video output system 10 will be described, and the issues to be solved by the embodiment will be described. FIG. 1 is an explanatory view showing one configuration example of the video output system 10 capable of realizing wireless transmission of the video signal.

### (Configuration of Video Output System 10)

As shown in FIG. 1, the video output system 10 includes a video reproduction device 12, a video display device 14, a wireless transmission device 16, a wireless reception device 18, and a video projecting device 20.

The video reproduction device 12 is a device for reproducing a video. For example, the video reproduction device 1 reads out and reproduces video recorded in BD (Blu-ray Disc), DVD (Digital Versatile Disc), HDD (Hard Disk Drive), or the like. The video reproduction device 12 may be a recordation and reproduction device capable of recording television video, and the like. Furthermore, the video reproduction device 12 may be PC, game machine, and the like.

The video reproduction device 12 may be wire connected to the video display device 14 or the wireless transmission device 16 using an HDMI cable, or the like. For instance, when the video reproduction device 12 and the video display device 14 are connected with the HDMI cable as shown in FIG. 1, the video signal output from the video reproduction device 12 is input to the video display device 14. The video display device 14 is a device for displaying the input video signal. Thus, when the video signal is input from the video reproduction device 12, the video signal is displayed on the video display device 14.

When the video reproduction device 12 and the wireless transmission device 16 are connected by the HDMI cable, the video signal output from the video reproduction device 12 is input to the wireless transmission device 16. In this case, the HDMI cable connected to the video display device 14 is detached from the video reproduction device 12. That is, the HDMI cable connected to the video display device 14 is replaced to connect the HDMI cable to the wireless transmission device 16. Suppose the HDMI cable is connected to the wireless transmission device 16.

In this case, the video signal is input from the video reproduction device 12 to the wireless transmission device 16. The wireless transmission device 16 wirelessly transmits the video signal input from the video reproduction device 12 to the wireless reception device 18 through the wireless channel. The video signal wirelessly transmitted by the wireless transmission device 16 is received by the wireless reception device 18. The video projecting device 20 is wire connected to the wireless reception device 18 by the HDMI cable. Thus, the video signal received by the wireless reception device 18 is input to the video projecting device 20 through the HDMI cable. The video projecting device 20 projects the video signal input from the wireless reception device 18 on the screen.

### (Organization of Issues)

As described above, the video output system 10 is a system capable of switching the output destination of the video signal between the video display device 14 and the video projecting device 29 by switching the connecting destination of the video reproduction device 12. Through the use of the video output system 10, for example, the recorded program can be normally viewed using the video display device 14, and a powerful video of a large screen can be enjoyed using the video projecting device 20 when viewing a movie. However, the HDMI cable wired between the video reproduction device 12 and the video display device 14 or the wireless transmission device 16 is replaced in order to switch the output destination of the video signal.

Normally, the cable such as the HDMI cable is not frequently detached from the video reproduction device 12, and thus a connection terminal is arranged on the rear surface of the video reproduction device 12. If the video reproduction device 12 is installed on a rack and the like of the television receiver, the video reproduction device 12 is once taken out from the rack and the like to replace the HDMI cable and the like. This is obviously the same for when the video reproduction device 12 is a PC, a game machine, and the like. Thus, it is very troublesome to move the video reproduction device 12 or to replace the HDMI cable and the like. As a result, the opportunity of using the video projecting device 20 decreases.

Thus, a technique of using by switching the output destination of the video signal between the video display device 14 and the video projecting device 20 without replacing the HDMI cable and the like is desired. In one embodiment of the present invention to be hereinafter described, a means for solving such technical issue is provided. The means will be described in detail below.

### Embodiment

One embodiment of the present invention will be described. The present embodiment relates to a technique of switching the output destination of the video signal between the wire connected video display device 14 and the wirelessly connected video projecting device 20 without replacing the HDMI cable and the like connected to the video reproduction device 12. Through the use of such technique, the user can easily switch the output destination of the video signal without replacing the HDMI cable and the like.

### [Configuration of Video Output System SYSTEM 1000]

First, the configuration of the video output system 1000 according to the present embodiment will be described with reference to FIG. 2. FIG. 2 is an explanatory view showing one configuration example of the video output system 1000 according to the present embodiment. The detailed description will be omitted by denoting the same reference numerals to the components having substantially the same function as the video output system 10 describe above.

As shown in FIG. 2, the video output system 1000 mainly includes the video reproduction device 12, the video display device 14, a wireless transmission device 100, a wireless reception device 200, and the video projecting device 20. The video reproduction device 12 and the wireless transmission device 100 may be integrally formed as a video reproduction unit 30. The video projecting device 20 and the wireless reception device 200 may be integrally formed as a video output unit 50.

As shown in FIG. 2, the video reproduction device 12 is wire connected to the wireless transmission device 100 using the HDMI cable, and the like. The video signal output from the video reproduction device 12 is input to the wireless transmission device 100. The wireless transmission device 100 is also connected to the video display device 14 in addition to the video reproduction device 12. The wireless transmission device 100 and the video display device 14 are wire connected by the HDMI cable, and the like. Thus, when the video signal is input from the wireless transmission device 100 to the video display device 14, the video is displayed at the video display device 14.

The wireless transmission device 100 can wirelessly transmit the video signal input from the video reproduction device 12 to the wireless reception device 200. In this case, the wireless transmission device 100 switches the output destination of the video signal input from the video reproduction device 12 from the video display device 14 to the wireless reception device 200. In this case, the user does not replace the HDMI cable and the like.

The video signal wirelessly transmitted from the wireless transmission device 100 is received by the wireless reception device 200. The video projecting device 20 is wire connected to the wireless reception device 200 by the HDMI cable and the like. Thus, the video signal received by the wireless reception device 200 is input to the video projecting device 20 through the HDMI cable and the like. The video projecting device 20 projects the video signal input from the wireless reception device 200 on the screen.

As described above, the video output system 1000 according to the present embodiment includes the wireless transmission device 100, and can easily switch the output destination of the video signal output from the video reproduction device 12 between the video display device 14 and the video projecting device 20. In order to obtain such effect, the wireless transmission device 100 is configured to switch the wire output to the video display device 14 and the wireless output to the wireless reception device 200 in the present embodiment. Thus, the user can easily switch the output destination of the video signal without the replacing the HDMI cable and the like by appropriately controlling the wireless transmission device 100 and switching the wire output and the wireless output.

### [Function Configuration of Wireless Transmission Device 100]

Next, the function configuration of the wireless transmission device 100 according to the present embodiment will be described with reference to FIG. 3. FIG. 3 is an explanatory view showing a function configuration example of the wireless transmission device 100 according to the present embodiment. As described above, the present embodiment relates to a technique of switch controlling the output destination of the video signal in the wireless transmission device 100. In the following description, description will be made centering on the function configuration regarding such control technique.

As shown in FIG. 3, the wireless transmission device 100 mainly includes a control unit 110 and a wireless communication unit 150. The control unit 110 controls the operation of each component of the wireless transmission device 100 and performs switch control regarding the output destination of the video signal. The wireless communication unit 150 executes the wireless communication process with the wireless reception device 200.

### (Control Unit 110)

First, each component included in the control unit 110 will be described. The control unit 110 includes an HDMI input terminal 112, a switch unit 114, an HDMI output terminal 116, an HDMI receiver 118, a central controller 120, a memory 122, a communication unit 124, an operation unit 126, a display unit 128, a power supply 130, and a power supply terminal 132.

The HDMI cable wired to the video reproduction device 12 is connected to the HDMI input terminal 112. The video signal is input from the video reproduction device 12 to the HDMI input terminal 112. The video signal input from the HDMI input terminal 112 is input to the switch unit 114. The switch unit 114 is connected with the HDMI output terminal 116 and the HDMI receiver 118, in addition to the HDMI input terminal 112. The HDMI output terminal 116 is connected to the video display device 14 by the HDMI cable. The HDMI receiver 118 is a means for wirelessly transmitting the video signal via the wireless communication unit 150.

The switch unit 114 is a means for switching the output destination of the video signal input from the HDMI input terminal 112 to the HDMI output terminal 116 or the HDMI receiver 118. When the output destination of the video signal is connected to the HDMI output terminal 116 by the switch unit 114, the video signal input from the HDMI input terminal 112 is input to the video display device 14 via the HDMI cable. When the output destination of the video signal is connected to the HDMI receiver 118 by the switch unit 114, the video signal input from the HDMI input terminal is wirelessly transmitted to the wireless reception device 200 through the wireless communication unit 150.

Ciphering such as HDCP (High-bandwidth Digital Content Protection) is performed on the video signal. In this case, the switch unit 114 outputs the video signal to the HDMI output terminal 116 or the HDMI receiver 118 without deciphering the cipher such as HDCP. When the video signal is the HDMI signal, the switch unit 114 outputs the TMDS (Transition Minimized Differential Signaling) signal, DDC (Display Data Channel) signal, CEC signal, +5V power supply, Hot Plug Detect signal, and the like as is regardless of the output destination.

In the HDMI receiver 118, the TMDS signal is analyzed, and separated to video signal, audio signal, and other signals. In the following description, however, such signals may be collectively referred to as video signal and the like or simply video signal. The video signal and the audio signal separated in the HDMI receiver 118 are input to the wireless communication unit 150, and wirelessly transmitted to the wireless reception device 200, as described above. The switch unit 114 and the HDMI receiver 118 are controlled by the central controller 120. In particular, the switch unit 114 is controlled by the central controller 120 using the CEC command.

The central controller 120 is configured by a CPU (Central Processing Unit), and executes the control process based on the program and the like recorded in the memory 122. In this case, the central controller 120 may use the data stored in the memory 122 for the control process or use the memory 122 as a cache.

An optical recording medium, a magnetic optical recording medium, a magnetic recording medium, a semiconductor recording medium, or the like is used for the memory 122. Various types of ROM (Read Only Memory), RAM (Random Access Memory), and the like are used for the memory 122. Furthermore, EEPROM (Electrically Erasable and Programmable Read Only Memory) may be mounted for the memory 122.

In addition to the switch unit 114, the HDMI receiver 118, and the memory 122, the communication unit 124, the operation unit 126, the display unit 128, and the power supply 130 are connected to the central controller 120. For instance, the communication data is input from the communication unit 124 to the central controller 120. Furthermore, an operation signal indicating user input is input from the operation unit 126 to the central controller 120. A state signal indicating the supply state of the power is input along with power from the power supply 130 to the central controller 120. The central controller 120 inputs the communication data to the communication unit 124. The central controller 120 also inputs display data to the display unit 128. Furthermore, the central controller 120 inputs the control signal for controlling ON/OFF of the power to the power supply 130. The power is supplied to the power supply 130 from an external power supply connected to the power supply terminal 132.

An operation button, a remote controller, and the like arranged at the exterior of the housing of the wireless transmission device 100, for example, are used for the operation unit 126. A power button for switching ON/OFF of the power, a display switch button for performing the switch operation of the information to display on the display unit 128, and the like are arranged for the operation button. The LED (Light Emitting Diode), the LCD (Liquid Crystal Display), and the like are used for the display unit 128. The OSD (On Screen Display) and the like is displayed in the LCD and the like, and serves to accept the user input in cooperation with the operation unit 126.

The central controller 120 is also connected to the wireless communication unit 150. In particular, the central controller 120 exchanges the control information with a communication controller 152 included in the wireless communication unit 150, and mutually shares the input state and the communication state of the video signal or the information regarding the output destination of the switch unit 114. As described above, the central controller 120 controls the operation of each component included in the wireless transmission device 100. Furthermore, the central controller 120 can control the operation of the video display device 14 connected to the HDMI output terminal 116. For instance, when the output destination of the video signal is switched to the HDMI receiver 118 by the switch unit 114, the power supply of the video display device 14 connected to the HDMI output terminal 116 can be turned OFF.

### (Wireless Communication Unit 150)

Each component included in the wireless communication unit 150 will now be described. The wireless communication unit 150 includes the communication controller 152, a baseband unit 154, a wireless communication unit 156, and an antenna 158.

The communication controller 152 is a means for controlling each component included in the wireless communication unit 150. For instance, the communication controller 152 controls modulation/demodulation process and the like by the baseband unit 154. The communication controller 152 is connected to the central controller 120 included in the control unit 110, and can acquire the information regarding the output destination of the switch unit 114, the input state of the video signal, and the like from the central controller 120. Furthermore, the communication controller 152 can notify to the central controller 120 the information regarding the state of the wireless reception device 200 and the video projecting device 20 acquired through the wireless channel, the information regarding the transmission quality of the wireless channel, or the like.

The baseband unit 154 modulates the video signal and the audio signal input from the HDMI receiver 118 included in the control unit 110, and inputs the same to the wireless communication unit 156. The wireless communication unit 156 transmits the RF signal input from the baseband unit 154 to the wireless reception device 200 by the antenna 158. The wireless communication unit 156 receives the RF signal using the antenna 158, and inputs the same to the baseband unit 154. When the RF signal is input from the wireless communication unit 156, the baseband unit 154 demodulates the RF signal and generates a baseband signal. The baseband signal generated by the baseband unit 154 is input to the communication controller 152, and transmitted to the central controller 120.

As described above, the wireless transmission device 100 can switch the output destination of the video signal between the wire output and the wireless output by including the switch unit 114 in the control unit 110. The switch control method of the switch unit 114, and various control processes involved in the switch process of the switch unit 114 will be described in detail hereinafter.

### [Function Configuration of Wireless Reception Device 200]

The function configuration of the wireless reception device 200 according to the present embodiment will be described with reference to FIG. 4. FIG. 4 is an explanatory view showing a function configuration example of the wireless reception device 200 according to the present embodiment.

As shown in FIG. 4, the wireless reception device 200 mainly includes a control unit 210 and a wireless communication unit 250. The control unit 210 controls the operation of each component of the wireless reception device 200. The wireless communication unit 250 executes the wireless communication process with the wireless transmission device 100.

### (Control Unit 210)

First, each component included in the control unit 210 will be described. The control unit 210 includes a central controller 212, a memory 214, a communication unit 222, an operation unit 224, a display unit 226, a power supply 216, a power supply terminal 218, and a control terminal 220.

The central controller 212 is configured by a CPU, and executes the control process based on the program and the like recorded in the memory 214. In this case, the central controller 212 may use the data stored in the memory 214 for the control process or use the memory 214 as a cache. An optical recording medium, a magnetic optical recording medium, a magnetic recording medium, a semiconductor recording medium, or the like is used for the memory 214. Various types of ROM, RAM, and the like are used for the memory 214. Furthermore, EEPROM may be mounted for the memory 214.

In addition to the memory 214, the communication unit 222, the operation unit 224, the display unit 226, and the power supply 216 are connected to the central controller 212. For instance, the communication data is input from the communication unit 222 to the central controller 212. Furthermore, an operation signal indicating user input is input from the operation unit 224 to the central controller 212. A state signal indicating the supply state of the power is input along with power from the power supply 216 to the central controller 212. The central controller 212 inputs the communication data to the communication unit 222. The central controller 212 also inputs display data to the display unit 226. Furthermore, the central controller 212 inputs the control signal for controlling ON/OFF of the power to the power supply 216. The power is supplied to the power supply 216 from an external power supply connected to the power supply terminal 218.

An operation button, a remote controller, and the like arranged at the exterior of the housing of the wireless reception device 200, for example, are used for the operation unit 224. A power button for switching ON/OFF of the power, a display switch button for performing the switch operation of the information to display on the display unit 226, and the like are arranged for the operation button. The LED, the LCD, and the like are used for the display unit 226. The OSD and the like is displayed in the LCD and the like, and serves to accept the user input in cooperation with the operation unit 224.

The central controller 212 is also connected to the wireless communication unit 250. In particular, the central controller 212 exchanges the control information with a communication controller 260 included in the wireless communication unit 250, and mutually shares the input state and the communication state of the video signal or the information regarding the output destination of the switch unit 114 of the wireless transmission device 100. The central controller 212 can also control the operation of the device (e.g., video projecting device 20) connected to the control terminal 220. For instance, when power OFF of the connected device is requested through the wireless communication unit 250, the central controller 212 turns OFF the power of the device connected to the control terminal 220.

### (Wireless Communication Unit 250)

Each component included in the wireless communication unit 250 will now be described. The wireless communication unit 250 includes the communication controller 260, an HDMI output terminal 258, a baseband unit 256, a wireless communication unit 254, and an antenna 252.

The communication controller 260 is a means for controlling each component included in the wireless communication unit 250. For instance, the communication controller 260 controls modulation/demodulation process and the like by the baseband unit 256. The communication controller 260 is connected to the central controller 212 included in the control unit 210, and can notify the information regarding the output destination of the switch unit 114 of the wireless transmission device 100, the input state of the video signal, and the like to the central controller 212. Furthermore, the communication controller 260 can notify to the central controller 212 the state information of the wireless transmission device 100 acquired through the wireless channel, and the information regarding the state of the video projecting device 20.

The wireless communication unit 254 receives the RF signal using the antenna 252 and inputs the same to the baseband unit 256. When the RF signal is input from the wireless communication unit 254, the baseband unit 256 demodulates the RF signal and generates the baseband signal. The baseband signal generated by the baseband unit 256 is input to the HDMI output terminal 258 or input to the communication controller 260, and transmitted to the central controller 212. For instance, when the video signal and the like are demodulated by the baseband unit 256, the video signal and the like are input to the HDMI output terminal 258.

The video projecting device 20 is connected to the HDMI output terminal 258 by the HDMI cable. Thus, when the video signal and the like are input from the baseband unit 256 to the HDMI output terminal 258, the video signal and the like are input to the video projecting device 20 through the HDMI cable. When the control signal and the like are demodulated by the baseband unit 256, the control signal and the like are input to the communication controller 260, and transmitted from the communication controller 260 to the central controller 212. The central controller 212 controls the operation of each component of the wireless reception device 200 or the device connected to the control terminal 220 based on the transmitted control signal and the like.

When the control signal and the like output from the central controller 212 are input to the baseband unit 256 through the communication controller 260, the baseband unit 256 modulates the control signal and the like input from the communication controller 260 and generates the RF signal. The RF signal generated by the baseband unit 256 is input to the wireless communication unit 254, and wirelessly transmitted to the wireless transmission device 100 via the antenna 252 by the wireless communication unit 254.

As described above, the wireless reception device 200 receives the video signal and the like from the wireless transmission device 100 and also exchanges state information, control information, and the like with the wireless transmission device 100. The wireless reception device 200 can also control the device connected to the control terminal 220 based on the control signal and the like received from the wireless transmission device 100. Furthermore, the wireless reception device 200 can transmit the control signal and the like acquired from the device connected to the control terminal 220 to the wireless transmission device 100.

### [Regarding Switch Control Method]

The switch control method of the output destination of the video signal according to the present embodiment will now be described with reference to FIGS. 5 to 9. FIGS. 5 to 9 are explanatory views for specifically describing a series of sequences related to the switch control process of the output destination of the video signal according to the present embodiment. Assume that the video projecting device 20 is connected to the control terminal 220 of the wireless reception device 200.

(Method of Switching Output Destination in Cooperation with Power Supply on Reception Side)

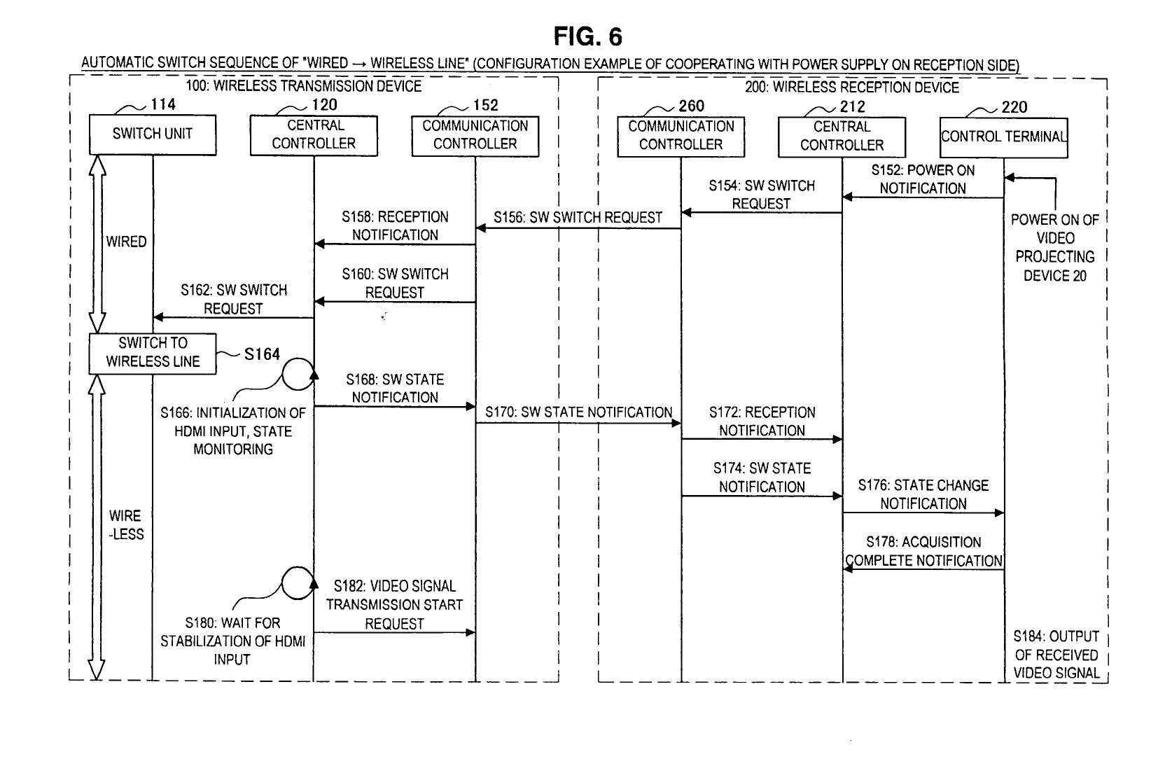

The method of switching the output destination of the video signal in cooperation with the power ON/OFF of the video projecting device 20 connected to the wireless reception device 200 will be described with reference to FIGS. 5 and 6. FIG. 5 shows a sequence of when switching the output destination of the video signal from the wireless output to the wired output in cooperation with the power OFF. FIG. 6 shows a sequence of when switching the output destination of the video signal from the wired output to the wireless output in cooperation with the power ON.

### (Wireless Output→Wired Output)

First, reference is made to FIG. 5. In the example of FIG. 5, the output destination of the video signal is set to the video projecting device 20, and the video signal is wirelessly transmitted from the wireless transmission device 100 to the wireless reception device 200. When the power of the video projecting device 20 is turned OFF in such state, the power OFF notification output from the video projecting device 20 is input to the central controller 212 through the control terminal 220 (S102). The power OFF notification referred herein is a change notification signal indicating that the power of the video projecting device 20 is changed to the OFF state. The central controller 212 transmits a SW switch request to the communication controller 260 when acquiring the power OFF notification through the control terminal 220 (S104). The SW switch request referred herein is an example of a control signal for switching the output destination of the video signal.

When the SW switch request is transmitted from the central controller 212 to the communication controller 260, the communication controller 260 wirelessly transmits the SW switch request to the communication controller 152 of the wireless transmission device 100 (S106). In this case, the communication controller 260 modulates the SW switch request to the RF signal by the baseband unit 256, and wirelessly transmits the RF signal by the wireless communication unit 254. The communication controller 152 of the wireless transmission device 100 demodulates the RF signal wirelessly received by the wireless communication unit 156 to the SW switch request by the baseband unit 154. The communication controller 152 transmits a reception notification to the central controller 120 (S108). The reception notification referred herein is a notification signal for notifying that the signal is received from the wireless reception device 200.

After the reception notification is transmitted from the communication controller 152 to the central controller 120, the communication controller 152 further transmits the SW switch request to the central controller 120 (S110). In this case, the SW switch request switches the output destination of the video signal from the wireless output to the wired output. When the reception notification and the SW switch request are transmitted from the communication controller 152 to the central controller 120, the central controller 120 transmits the SW state notification to the communication controller 152 (S112). The SW state notification referred herein is a state notification signal indicating whether the output destination of the switch unit 114 is the HDMI output terminal 116 or the HDMI receiver 118. In this case, the output destination of the video signal is switched to the HDMI output terminal 116 by the SW switch request, and thus SW state notification indicates that the output destination is the HDMI output terminal 116 (wired output).

When the SW state notification is transmitted from the central controller 120 to the communication controller 152, the communication controller 152 transmits the SW state notification to the communication controller 260 of the wireless reception device 200 (S114). In this case, the communication controller 152 modulates the SW state notification to the RF signal by the baseband unit 154, and transmits the RF signal from the wireless communication unit 156. When the SW state notification is transmitted from the communication controller 152 to the communication controller 260 of the wireless reception device 200, the communication controller 260 of the wireless reception device 200 transmits the reception notification to the central controller 212 (S116).

After the reception notification is transmitted from the communication controller 260 to the central controller 212, the communication controller 260 further transmits the SW state notification to the central controller 212 (S118). In this case, the communication controller 260 inputs the RF signal received by the wireless communication unit 254 to the baseband unit 256, and demodulates the SW state notification by the baseband unit 256. When the SW state notification is transmitted from the communication controller 260 to the central controller 212, the central controller 212 inputs the state change notification to the control terminal 220, and transmits the state change notification to the video projecting device 20 (S120). When the state change notification is transmitted to the video projecting device 20 through the control terminal 220, an acquisition complete notification is transmitted to the central controller 212 through the control terminal 220 (S122).

In the wireless transmission device 100, after the SW state notification is transmitted from the central controller 120 to the communication controller 152, a video signal transmission stop request is transmitted from the central controller 120 to the communication controller 152 (S124). The video signal transmission stop request referred herein is a control signal for controlling the communication controller 152 so that the video signal is not wirelessly transmitted to the wireless reception device 200. Thus, when the video signal transmission stop request is transmitted from the central controller 120 to the communication controller 152, the communication controller 152 stops the wireless transmission of the video signal with respect to the wireless reception device 200. For instance, the communication controller 152 controls the baseband unit 154 and stops the wireless transmission of the video signal even when the video signal is input to the baseband unit 154 from the HDMI receiver 118.

After the video signal transmission stop request is transmitted from the central controller 120 to the communication controller 152, the central controller 120 transmits the SW switch request to the switch unit 114 (S126). When the SW switch request is transmitted from the central controller 120 to the switch unit 114, the switch unit 114 switches the output destination of the video signal from the HDMI receiver 118 to the HDMI output terminal 116 (S128). When the switch process of the output destination by the switch unit 114 is completed, the output destination of the video signal is switched to the wired output, and the video is displayed on the video display device 14.

### (Wired Output→Wireless Output)

Next, reference is made to FIG. 6. In the example of FIG. 6, the output destination of the video signal is set to the video display device 14, and the video signal is not wirelessly transmitted from the wireless transmission device 100 to the wireless reception device 200. When the power of the video projecting device 20 is turned ON in such state, the power ON notification output from the video projecting device 20 is input to the central controller 212 through the control terminal 220 (S152). The power ON notification referred herein is a change notification signal indicating that the power of the video projecting device 20 is changed to the ON state. The central controller 212 transmits a SW switch request to the communication controller 260 when acquiring the power ON notification through the control terminal 220 (S154). The SW switch request referred herein is an example of a control signal for switching the output destination of the video signal.

When the SW switch request is transmitted from the central controller 212 to the communication controller 260, the communication controller 260 wirelessly transmits the SW switch request to the communication controller 152 of the wireless transmission device 100 (S156). In this case, the communication controller 260 modulates the SW switch request to the RF signal by the baseband unit 256, and wirelessly transmits the RF signal by the wireless communication unit 254. The communication controller 152 of the wireless transmission device 100 demodulates the RF signal wirelessly received by the wireless communication unit 156 to the SW switch request by the baseband unit 154. The communication controller 152 transmits a reception notification to the central controller 120 (S158). The reception notification referred herein is a notification signal for notifying that the signal is received from the wireless reception device 200.

After the reception notification is transmitted from the communication controller 152 to the central controller 120, the communication controller 152 further transmits the SW switch request to the central controller 120 (S160). In this case, the SW switch request switches the output destination of the video signal from the wired output to the wireless output. When the SW switch request is transmitted from the communication controller 152 to the central controller 120, the central controller 120 transmits the SW switch request to the switch unit 114 (S162). When the SW switch request is transmitted from the central controller 120 to the switch unit 114, the switch unit 114 switches the output destination of the video signal from the HDMI output terminal 116 to the HDMI receiver 118 (S164).

After the SW switch request is transmitted from the central controller 120 to the switch unit 114, the central controller 120 initializes the HDMI input and monitors the SW state (S166). The SW state referred herein is a state in which the output destination of the video signal is the HDMI output terminal 116 or the HDMI receiver 118. When the switch of the SW state by the central controller 120 is detected, the SW state notification is transmitted from the central controller 120 to the communication controller 152 (S168). In this case, the output destination of the video signal is switched to the HDMI receiver 118 by the SW switch request, and thus the SW state notification indicates that the output destination is the HDMI receiver 118 (wireless output).

When the SW state notification is transmitted from the central controller 120 to the communication controller 152, the communication controller 152 transmits the SW state notification to the communication controller 260 of the wireless reception device 200 (S170). In this case, the communication controller 152 modulates the SW state notification to the RF signal by the baseband unit 154, and transmits the RF signal from the wireless communication unit 156. When the SW state notification is transmitted from the communication controller 152 to the communication controller 260 of the wireless reception device 200, the communication controller 260 of the wireless reception device 200 transmits the reception notification to the central controller 212 (S172).

After the reception notification is transmitted from the communication controller 260 to the central controller 212, the communication controller 260 transmits the SW state notification to the central controller 212 (S174). In this case, the communication controller 260 inputs the RF signal received by the wireless communication unit 254 to the baseband unit 256, and demodulates the SW state notification by the baseband unit 256. When the SW state notification is transmitted from the communication controller 260 to the central controller 212, the central controller 212 inputs the state change notification to the control terminal 220, and transmits the state change notification to the video projecting device 20 (S176). When the state change notification is transmitted to the video projecting device 20 through the control terminal 220, the acquisition complete notification is transmitted to the central controller 212 through the control terminal 220 (S178).

After the SW state notification is transmitted from the central controller 120 to the communication controller 152 of the wireless transmission device 100, the central controller 120 waits until the state of the HDMI input stabilizes while monitoring (S180). When the HDMI input stabilizes, the central controller 120 transmits the video signal transmission start request to the communication controller 152 (S182). The video signal transmission start request referred herein is a control signal for controlling the communication controller 152 so that the video signal is wirelessly transmitted to the wireless reception device 200. Thus, when the video signal transmission start request is transmitted from the central controller 120 to the communication controller 152, the communication controller 152 starts the wireless transmission of the video signal with respect to the wireless reception device 200.

When the wireless transmission of the video signal starts by the communication controller 152, the video signal is output from the HDMI output terminal 258 of the wireless reception device 200. When the video signal is output from the HDMI output terminal 258, the video is projected on the screen by the video projecting device 20 connected to the HDMI output terminal 258 (S184).

As described above, in the video output system 1000 according to the present embodiment, the wireless transmission device 100 is controlled such that the output destination of the video signal is switched in cooperation with the power ON/OFF of the device connected to the control terminal 220 of the wireless reception device 200.

(Method of Controlling Power Supply on Reception Side in Cooperation with Switch Operation on Transmission Side)

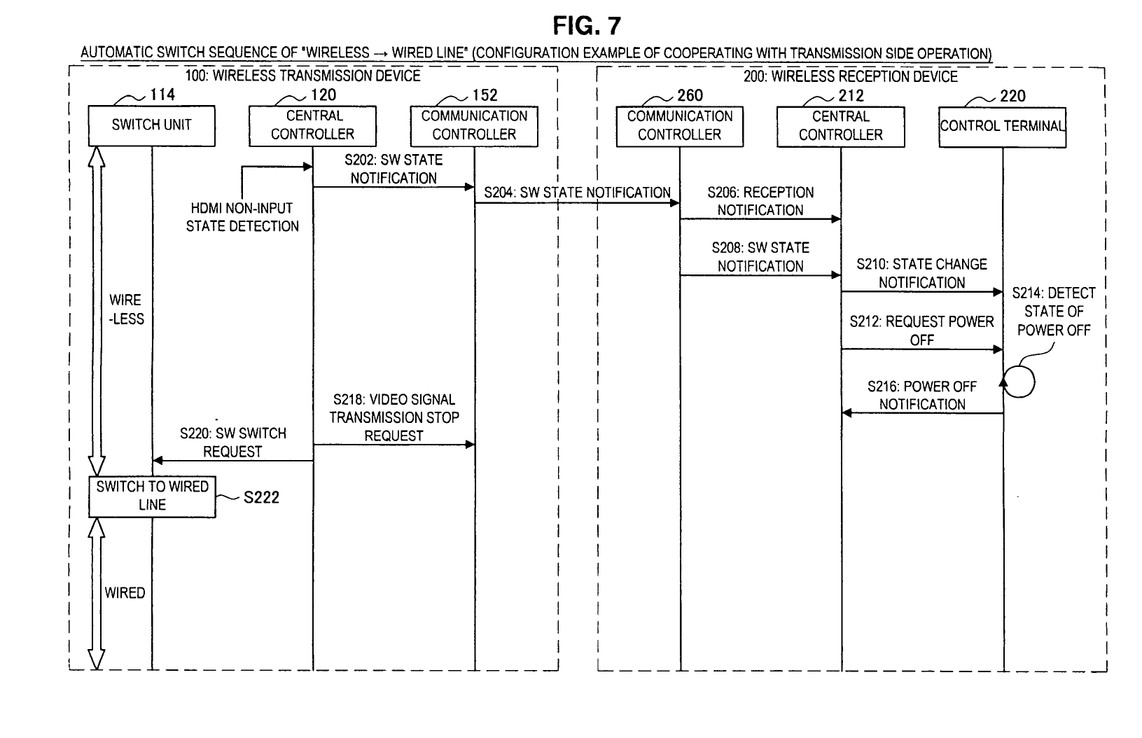

The method of turning OFF the power of the video projecting device 20 connected to the wireless reception device 200 in cooperation with the switch of the output destination of the switch unit 114 of the wireless transmission device 100 will be described with reference to FIG. 7. FIG. 7 is an explanatory view showing a method of automatically turning OFF the power of the video projecting device 20 connected to the wireless reception device 200 when the output destination of the switch unit 114 of the wireless transmission device 100 is switched to wired output.

In the example of FIG. 7, the output destination of the video signal is set to the video projecting device 20, and the video signal is wirelessly transmitted from the wireless transmission device 100 to the wireless reception device 200. When the output destination of the video signal is changed to the video display device 14 by user operation in this state, the SW state notification is transmitted from the central controller 120 to the communication controller 152 (S202). The SW state notification referred herein is a state notification signal indicating whether the output destination of the switch unit 114 is the HDMI output terminal 116 or the HDMI receiver 118. In this case, since the output destination of the video signal is switched to the HDMI output terminal 116 by the SW switch request, the SW state notification indicates that the output destination is the HDMI output terminal 116 (wired output).

When the SW state notification is transmitted from the central controller 120 to the communication controller 152, the communication controller 152 transmits the SW state notification to the communication controller 260 of the wireless reception device 200 (S204). In this case, the communication controller 152 modulates the SW state notification to the RF signal by the baseband unit 154, and transmits the RF signal from the wireless communication unit 156. When the SW state notification is transmitted from the communication controller 152 to the communication controller 260 of the wireless reception device 200, the communication controller 260 of the wireless reception device 200 transmits the reception notification to the central controller 212 (S206).

After the reception notification is transmitted from the communication controller 260 to the central controller 212, the communication controller 260 further transmits the SW state notification to the central controller 212 (S208). In this case, the communication controller 260 inputs the RF signal received by the wireless communication unit 254 to the baseband unit 256, and demodulates the SW state notification by the baseband unit 256. When the SW state notification is transmitted from the communication controller 260 to the central controller 212, the central controller 212 inputs the state change notification to the control terminal 220, and transmits the state change notification to the video projecting device 20 (S210).

After the state change notification is input from the central controller 212 to the control terminal 220, the central controller 212 transmits a power OFF request to the video projecting device 20 through the control terminal (S212). The power OFF request referred herein is a control signal for controlling the video projecting device 20 to turn OFF the power. When the power OFF request is transmitted from the central controller 212 to the video projecting device 20 through the control terminal 220, and the power OFF of the video projecting device 20 is detected (S214), a power OFF notification is transmitted from the video projecting device 20 to the central controller 212 through the control terminal 220 (S216). The power OFF notification referred herein is a state notification signal for notifying that the power is turned OFF.

In the wireless transmission device 100, after the SW state notification is transmitted from the central controller 120 to the communication controller 152, a video signal transmission stop request is transmitted from the central controller 120 to the communication controller 152 (S218). The video signal transmission stop request referred herein is a control signal for controlling the communication controller 152 so that the video signal is not wirelessly transmitted to the wireless reception device 200. Thus, when the video signal transmission stop request is transmitted from the central controller 120 to the communication controller 152, the communication controller 152 stops the wireless transmission of the video signal with respect to the wireless reception device 200. For instance, the communication controller 152 controls the baseband unit 154 and stops the wireless transmission of the video signal even when the video signal is input to the baseband unit 154 from the HDMI receiver 118.

After the video signal transmission stop request is transmitted from the central controller 120 to the communication controller 152, the central controller 120 transmits the SW switch request to the switch unit 114 (S220). When the SW switch request is transmitted from the central controller 120 to the switch unit 114, the switch unit 114 switches the output destination of the video signal from the HDMI receiver 118 to the HDMI output terminal 116 (S222). When the switch process of the output destination by the switch unit 114 is completed, the output destination of the video signal is switched to the wired output, and the video is displayed on the video display device 14.

(Method of Controlling Power Supply on Reception Side in Cooperation with HDMI Input State)

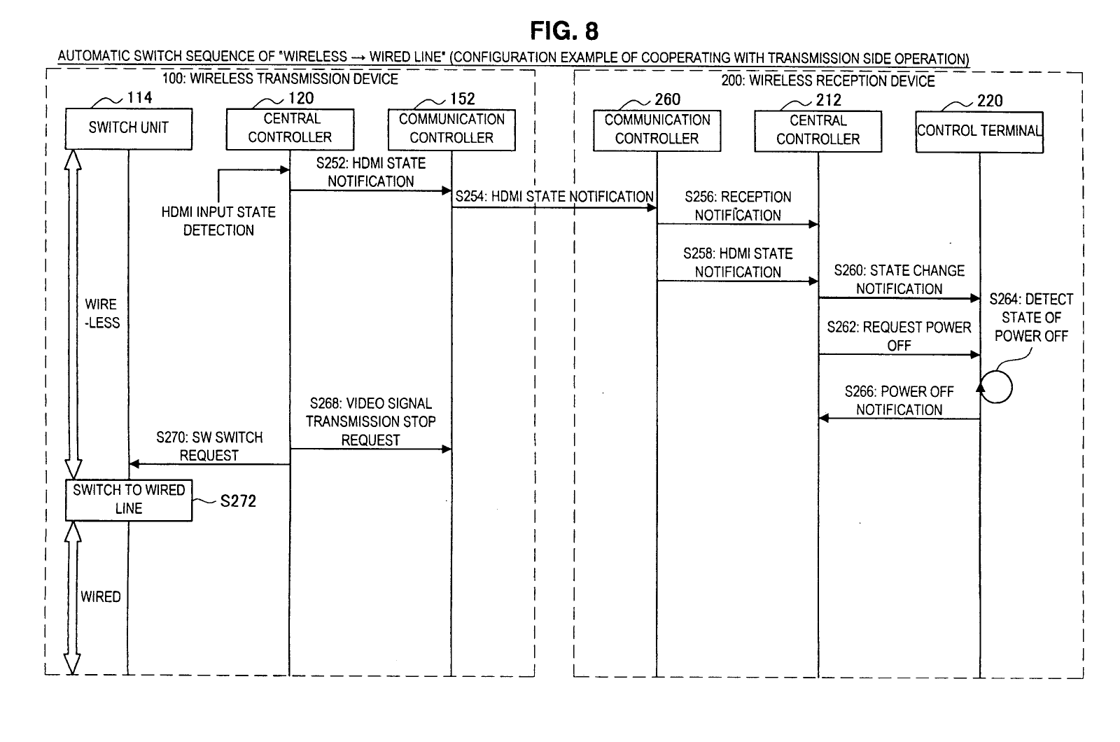

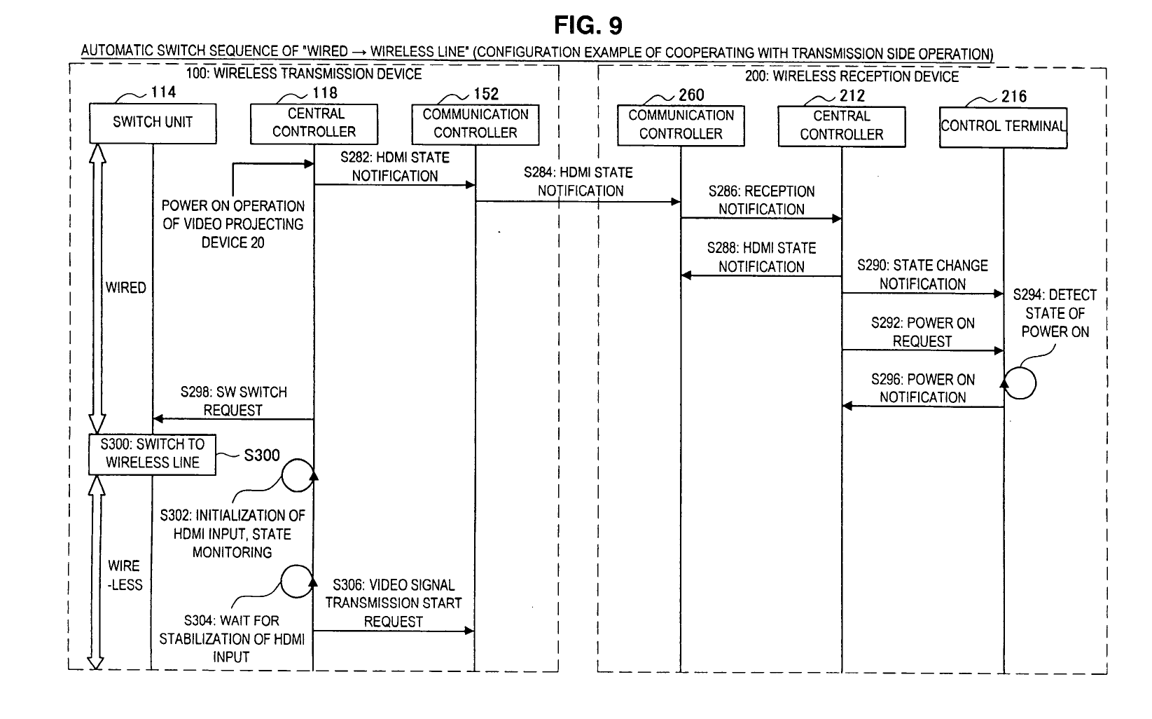

The method of turning ON/OFF the power of the video projecting device 20 connected to the wireless reception device 200 in cooperation with the change in the HDMI input state input from the video reproduction device 12 will be described with reference to FIGS. 8 and 9.

FIG. 8 is an explanatory view showing a method of automatically turning OFF the power of the video projecting device 20 connected to the wireless reception device 200 when the non-input state of the HDMI signal input from the video reproduction device 12 is detected. FIG. 9 is an explanatory view showing a method of automatically turning ON the power of the video projecting device 20 connected to the wireless reception device 200 when the re-input state of the HDMI signal input from the video reproduction device 12 is detected.

### (Input State Non-Input State)

First, FIG. 8 will be described. In the example of FIG. 8, the output destination of the video signal is set to the video projecting device 20, and the video signal is wirelessly transmitted from the wireless transmission device 100 to the wireless reception device 200. When the non-input state of the HDMI signal is detected in this state, the HDMI state notification is transmitted from the central controller 120 to the communication controller 152 (S252). The HDMI state notification referred herein is a state notification signal indicating whether or not the HDMI signal is input. In this case, the HDMI state notification indicates that the HDMI signal is non-input.

When the HDMI state notification is transmitted from the central controller 120 to the communication controller 152, the communication controller 152 transmits the HDMI state notification to the communication controller 260 of the wireless reception device 200 (S254). In this case, the communication controller 152 modulates the HDMI state notification to the RF signal by the baseband unit 154, and transmits the RF signal from the wireless communication unit 156. When the HDMI state notification is transmitted from the communication controller 152 to the communication controller 260 of the wireless reception device 200, the communication controller 260 of the wireless reception device 200 transmits the reception notification to the central controller 212 (S256).

After the reception notification is transmitted from the communication controller 260 to the central controller 212, the communication controller 260 further transmits the HDMI state notification to the central controller 212 (S258). In this case, the communication controller 260 inputs the RF signal received by the wireless communication unit 254 to the baseband unit 256, and demodulates the HDMI state notification by the baseband unit 256. When the HDMI state notification is transmitted from the communication controller 260 to the central controller 212, the central controller 212 inputs the state change notification to the control terminal 220, and transmits the state change notification to the video projecting device 20 (S260).

After the state change notification is input from the central controller 212 to the control terminal 220, the central controller 212 transmits the power OFF request to the video projecting device 20 through the control terminal 220 (S262). The power OFF request referred herein is a control signal for controlling the video projecting device 20 to turn OFF the power. When the power OFF request is transmitted from the central controller 212 to the video projecting device 20 through the control terminal 220, and the power OFF of the video projecting device 20 is detected (S264), a power OFF notification is transmitted from the video projecting device 20 to the central controller 212 through the control terminal 220 (S266). The power OFF notification referred herein is a state notification signal for notifying that the power is turned OFF.

In the wireless transmission device 100, after the HDMI state notification is transmitted from the central controller 120 to the communication controller 152, the video signal transmission stop request is transmitted from the central controller 120 to the communication controller 152 (S268). The video signal transmission stop request referred herein is a control signal for controlling the communication controller 152 so that the video signal is not wirelessly transmitted to the wireless reception device 200. Thus, when the video signal transmission stop request is transmitted from the central controller 120 to the communication controller 152, the communication controller 152 stops the wireless transmission of the video signal to the wireless reception device 200. For instance, even if the video signal is input from the HDMI receiver 118 to the baseband unit 154, the communication controller 152 controls the baseband unit 154 and stops the wireless transmission of the video signal.

After the video signal transmission stop request is transmitted from the central controller 120 to the communication controller 152, the central controller 120 transmits the SW switch request to the switch unit 114 (S270). When the SW switch request is transmitted from the central controller 120 to the switch unit 114, the switch unit 114 switches the output destination of the video signal from the HDMI receiver 118 to the HDMI output terminal 116 (S272). When the switch process of the output destination by the switch unit 114 is completed, the wireless output is not immediately carried out even if the HDMI signal recovers to the input state, and thus power supply amount of the wireless communication unit 150 can be reduced or stopped thereby saving power.

### (Non-Input State→Input State)

Next, FIG. 9 is referenced. In the example of FIG. 9, the output destination of the video signal is set to the video display device 140, and the video signal is not wirelessly transmitted from the wireless transmission device 100 to the wireless reception device 200. When the input state of the HDMI signal is detected in this state, the HDMI state notification is transmitted from the central controller 120 to the communication controller 152 (S282). The HDMI state notification referred herein is a state notification signal indicating whether or not the HDMI signal is input. In this case, the HDMI state notification indicates that the HDMI signal is in the input state.

When the HDMI state notification is transmitted from the central controller 120 to the communication controller 152, the communication controller 152 transmits the HDMI state notification to the communication controller 260 of the wireless reception device 200 (S284). In this case, the communication controller 152 modulates the HDMI state notification to the RF signal by the baseband unit 154, and transmits the RF signal from the wireless communication unit 156. When the HDMI state notification is transmitted from the communication controller 152 to the communication controller 260 of the wireless reception device 200, the communication controller 260 of the wireless reception device 200 transmits the reception notification to the central controller 212 (S286).

After the reception notification is transmitted from the communication controller 260 to the central controller 212, the communication controller 260 further transmits the HDMI state notification to the central controller 212 (S288). In this case, the communication controller 260 inputs the RF signal received by the wireless communication unit 254 to the baseband unit 256, and demodulates the HDMI state notification by the baseband unit 256. When the HDMI state notification is transmitted from the communication controller 260 to the central controller 212, the central controller 212 inputs the state change notification to the control terminal 220, and transmits the state change notification to the video projecting device 20 (S290).

After the state change notification is input from the central controller 212 to the control terminal 220, the central controller 212 transmits the power ON request to the video projecting device 20 through the control terminal 220 (S292). The power ON request referred herein is a control signal for controlling the video projecting device 20 to turn ON the power. When the power ON request is transmitted from the central controller 212 to the video projecting device 20 through the control terminal 220, and the power ON of the video projecting device 20 is detected (S294), a power ON notification is transmitted from the video projecting device 20 to the central controller 212 through the control terminal 220 (S296). The power ON notification referred herein is a state notification signal for notifying that the power is turned ON.

In the wireless transmission device 100, after the HDMI state notification is transmitted from the central controller 120 to the communication controller 152, the central controller 120 transmits the SW switch request to the switch unit 114 (S298). In this case, the SW switch request switches the output destination of the video signal from the wired output to the wireless output. When the SW switch request is transmitted from the central controller 120 to the switch unit 114, the switch unit 114 switches the output destination of the video signal from the HDMI output terminal 116 to the HDMI receiver 118 (S300). [0104]

After the SW switch request is transmitted from the central controller 120 to the switch unit 114, the central controller 120 initializes the HDMI input and monitors the SW state (S302). The SW state referred herein is a state in which the output destination of the video signal is the HDMI output terminal 116 or the HDMI receiver 118. The central controller 120 waits until the state of the HDMI input stabilizes while monitoring (S304).

When the HDMI input stabilizes, the central controller 120 transmits the video signal transmission start request to the communication controller 152 (S306). The video signal transmission start request referred herein is a control signal for controlling the communication controller 152 so that the video signal is wirelessly transmitted to the wireless reception device 200. Thus, when the video signal transmission start request is transmitted from the central controller 120 to the communication controller 152, the communication controller 152 starts the wireless transmission of the video signal with respect to the wireless reception device 200.

As described above, the output destination can be switched according to the input state of the HDMI signal, and the power supply amount of the wireless communication unit 150 can be controlled. Even if the HDMI signal is not input and the power of the video projecting device 20 connected to the wireless reception device 200 is turned OFF, the power is automatically turned ON at the point the input state of the HDMI signal is recovered. Furthermore, the power supply amount of the wireless communication unit 150 is controlled, and the HDMI signal is automatically wirelessly transmitted to the video projecting device 20 which power is turned ON. The user thus can save the power of the wireless transmission device 100 and the video projecting device 20 without operating the wireless transmission device 100 and the video projecting device 20 each time.

### [CEC Command]

The configuration of the control command used when switching the output destination of the video signal will be described with reference to FIG. 10. FIG. 10 is an explanatory view for describing the technical issue that arises when the CEC command is used for the switching of the output destination. The control command focused here is used to control the switch unit 114 of the wireless transmission device 100 from the wireless reception device 200. The following issues arise when the switch unit 114 of the wireless transmission device 100 is controlled from the wireless reception device 200 using the CEC command.

Reference is made to FIG. 10. FIG. 10 schematically shows two states (state (1), state (2)) in a certain video output system. As shown in FIG. 10, the video output system includes two display devices R1, R2, a switch C1, and a video reproduction device T1. The video reproduction device T1 is connected to an input terminal IN of the switch C1. A first display device R1 and a second display device R2 are connected to two output terminals OUT1, OUT2 of the switch C1, respectively. A case of switching the output destination of the switch C1 from the first display device R1 with the CEC command in the video output system will be considered.

In the state (1), the output destination of the switch C1 is connected to the output terminal OUT1. In this case, the display device seen from the switch C1 and the video reproduction device T1 is recognized to be only the first display device R1. When the CEC command (OUT1 OUT2) is input from the first display device R1 to the switch C1 in this state, the switch C1 can switch the output destination from the output terminal OUT1 to the output terminal OUT2. The state after the switch control by the CEC command (OUT1 OUT2) is the state (2).

In the state (2), the output destination of the switch C1 is connected to the output terminal OUT2. In this case, the switch C1 and the video reproduction device T1 recognize the second display device R2 as the display device. When the CEC command is transmitted from the first display device R1 to the switch C1 in this state, the switch C1 does not accept the CEC command transmitted from the first display device R1. This is because the CEC has a configuration of managing the entire system with the tree structure having the display device (SINK) as one vertex. That is, when the CEC command is transmitted from the first display device R1 to the switch C1 in the state (2), two SINKs will exist in the system and contradiction occurs.

As a result, the CEC command transmitted from the first display device R1 is not accepted by the switch C1 in the state (2), and the output destination of the video signal may not be switched from the output terminal OUT2 to the output terminal OUT1. In order to solve such technical issue, the CEC command is not used for the control signal for switching the output terminal of the switch C1 from the first display device R1 in the present embodiment.

In the video output system 1000, the first display device R1 corresponds to the video output unit 50, and the second display device R2 corresponds to the video display device 14. The switch C1 corresponds to the wireless transmission device 100 and the video reproduction device T1 corresponds to the video reproduction device 12. The control terminal 220 is provided to the wireless reception device 200 to acquire the control signal from the video projecting device 20 in the video output system 1000.

For instance, when the output destination of the video signal is switched in cooperation with power OFF and the like of the video projecting device 20, the control signal different from the CEC command is transmitted from the video projecting device 20 through the control terminal 220. According to such configuration, the technical issue originating from the CEC command can be solved. The technical issue originating from the CEC command can be solved even in a state where the first display device R1 corresponds to the video display device 14 and the second display device R2 corresponds to the video projecting device 20 by applying the configuration example of the above description.

The system configuration of the video output system 1000 according to the present embodiment, the function configuration of the wireless transmission device 100, the function configuration of the wireless reception device 200, and the method of switch controlling the output destination of the video signal have been described above. The wireless output and the wired output of the video signal can be switched without replacing the HDMI cable and the like by applying the technique of the present embodiment. Furthermore, the technical issue originating from the CEC command when using the display output of two systems in the system handling the HDMI signal can be solved by applying the technique of the present embodiment.

Variants of the present embodiment will be introduced with reference to FIGS. 11 to 13.

FIG. 11 is an explanatory view showing a variant in which the switch unit 114 of the wireless transmission device 100 has a multi-input single-output configuration (Variant 1). As in variant 1, a plurality of HDMI input terminals 1121, 1122, 1123 may be arranged, so that the video signal input from a plurality of signal lines can be switched between the HDMI output terminal 116 and the wireless communication unit 150 and output.

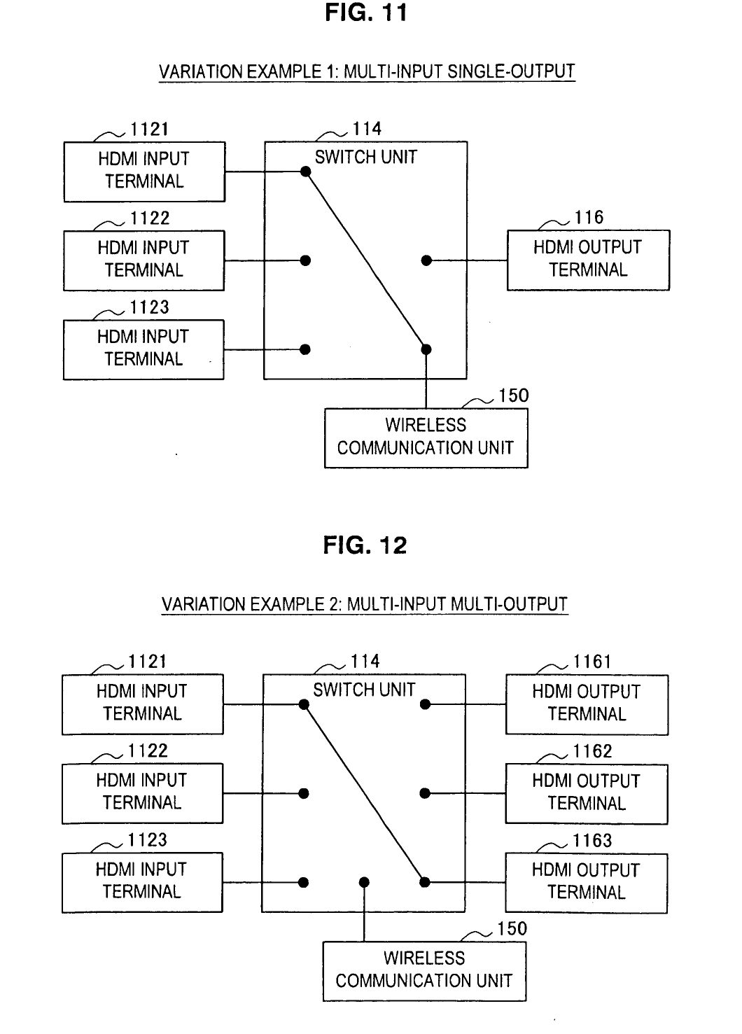

FIG. 12 is an explanatory view showing a variant in which the switch unit 114 of the wireless transmission device 100 has a multi-input multi-output configuration (Variant 2). As in variant 2, a plurality of HDMI input terminals 1121, 1122, 1123 may be arranged, so that the video signal input from a plurality of signal lines can be selectively switched between a plurality of HDMI output terminals 1161, 1162, 1163 and the wireless communication unit 150.

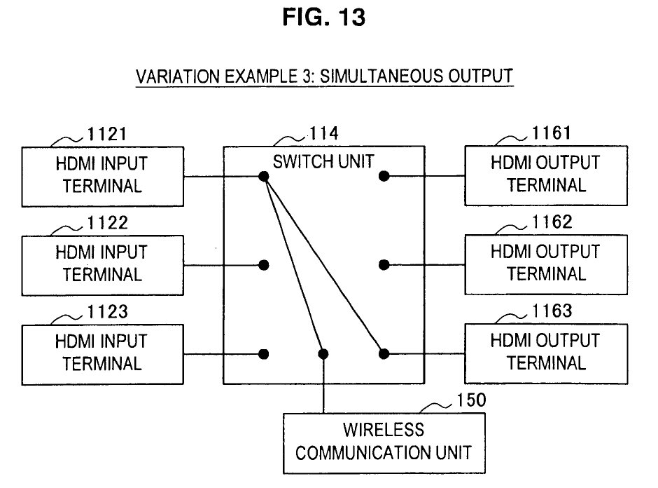

FIG. 13 is an explanatory view showing a variant in which the switch unit 114 of the wireless transmission device 100 has a multi-input multi-output configuration (Variant 3). The video signal input from one HDMI input terminal 1121 is simultaneously output to the HDMI output terminal 1163 and the wireless communication unit 150. If a plurality of output destinations exists including the output to the wireless communication unit 150, the video signal may be simultaneously output to a plurality of output destinations.

### CONCLUSION

Lastly, the function configuration of the video transmission apparatus of the present embodiment and the effects obtained by such function configuration will be briefly summarized. The wireless transmission device 100 is an example of the video transmission apparatus.

First, the function configuration of the video transmission apparatus according to the present embodiment can be expressed as below. The video transmission apparatus includes an input terminal, an output terminal, a wireless transmission unit, an output switch unit, and a switch controller. The HDMI input terminal 112 is an example of the input terminal. The HDMI output terminal 116 is an example of the output terminal. The wireless communication unit 150 is an example of the wireless transmission unit. The switch unit 114 is an example of the output switch unit. The central controller 120 is an example of the switch controller.

The video signal is input to the input terminal. The output terminal is wire connected to the video device. The video display device 14 is an example of the video device. The wireless transmission unit modulates the video signal through a predetermined wireless modulation method and wirelessly transmits the same. The output switch unit is connected to the input terminal, the output terminal, and the wireless transmission unit, so that the output destination of the video signal input from the input terminal is switched to the output terminal or the wireless transmission unit.

The output destination of the video signal can be switched between the wired output and the wireless output by arranging the output switch unit. When receiving the switch request of the output destination by the wireless communication unit, the switch controller causes the output switch unit to switch the output destination of the video signal in response to the switch request. The output destination of the video signal can be automatically switched according to the state change (power ON/OFF etc.) at the transmitting destination of the video signal by arranging the switch controller.

The video signal is an HDMI signal, and the switch request is a control signal different from a CEC command. In this case, the switch controller causes the output switch unit to switch the output destination of the video signal in response to the control signal. According to such configuration, regardless of the restriction arising from the control system of the CEC built with one SINK as the vertex of the tree, the output destination of the video signal can be switched from the SINK side in the system including two SINKS.

The switch controller controls the output switch unit to switch the output destination of the video signal to the output terminal when power is turned OFF at the output destination of the video signal wirelessly transmitted by the wireless transmission unit or when the video signal input to the input terminal is changed to a non-input state. According to such configuration, when the power of the wireless transmitting destination of the video signal is turned OFF or the input of the video signal is stopped, the power supply of the wireless communication unit can be reduced or stopped. As a result, the consumed power of the video transmission apparatus can be reduced.

The output switch unit outputs the video signal to the output terminal or the wireless transmission unit without canceling HDCP performed on the HDMI signal. Since the video signal is output without canceling the HDCO, the calculation load with respect to the cancellation of the HDCP does not generate, and the speed of switch output of the video signal becomes higher. Furthermore, a circuit used for the cancellation process of the HDCP is unnecessary, whereby the circuit scale can be reduced. As a result, the manufacturing cost can be reduced compared to that in which the HDCP is canceled.

Further, the video transmission apparatus according to the present embodiment can be expressed as below.

The video transmission apparatus includes an input terminal input with a video signal, an output terminal wire connected to a video device, a wireless transmission unit for modulating the video signal through a predetermined wireless modulation method and wirelessly transmitting the modulated video signal, an output switch unit, connected with the input terminal, the output terminal, and the wireless transmission unit, for switching an output destination of the video signal input from the input terminal to the output terminal or the wireless transmission unit, and the switch control unit for causing the output switch unit to switch the output destination of the video signal and causing the wireless transmission unit to transmit a switch notification notifying the switching of the output destination.

The difference with the video transmission apparatus described above lies in the configuration of the switch controller. In this expression, when the output destination of the video signal is changed by the switch controller, the change of the output destination is wirelessly transmitted. According to such configuration, the control of the operation cooperating with the switch process of the output destination can be performed in the device of the wireless transmitting destination. For instance, when the output destination is changed to wire connection, the power of the wireless transmitting destination can be controlled to OFF. Consequently, the user can automatically turn OFF the power of the device of the wireless transmitting destination without moving to the side of the wireless transmitting destination by simply switching the output destination of the video signal.

It should be understood by those skilled in the art that various modifications, combinations, sub-combinations and alterations may occur depending on design and other factors insofar as they are within the scope of the appended claims or the equivalents thereof.

In the above description, a configuration in which the output destination of the video signal is changed in cooperation with the power ON/OFF on the reception side has been described. A configuration in which the power ON/OFF on the reception side is switched in cooperation with the switching of when the output destination of the video signal is switched has also been described. Moreover, a configuration in which the power ON/OFF on the reception side is switched in cooperation with the change in input state when the input state of the video signal is changed on the transmission side has been described. The following configuration is considered as an application example in addition to such configurations.

When the device of the wireless output destination switches the input terminal from a wireless input to another input with the video signal being wirelessly output, the output destination of the video signal may be switched to the wired output. When the device of the wireless output destination switches the input terminal to the wireless input with the video signal being wire connected, the output destination of the video signal may be switched to the wireless output. Furthermore, when the state of the wireless channel is degraded and the video signal is greatly disturbed with the video signal being wirelessly output, the output destination of the video signal may be switched to the wired output. On the contrary, when the state of the wireless channel is recovered, the output destination of the video signal may be automatically switched to the wireless output.

The present application contains subjected matter related to that disclosed in Japanese Priority Patent Application JP 2008-204740 filed in the Japan Patent Office on Aug. 7, 2008, the entire contents of which is hereby incorporated by reference.

What is claimed is:

1. A video transmission apparatus comprising:
an input terminal input with a video signal;
an output terminal wire connected to a video device;
a wireless communication unit for modulating the video signal through a predetermined wireless modulation method and wirelessly transmitting the modulated video signal;
an output switch unit, connected with the input terminal, the output terminal, and the wireless transmission unit, for switching an output destination of the video signal input from the input terminal to the output terminal or the wireless transmission unit; and
a switch controller for causing the output switch unit to switch the output destination of the video signal in response to a switch request when receiving the switch request of the output destination by the wireless communication unit.

2. The video transmission apparatus according to claim 1, wherein
the video signal is an HDMI (High-Definition Multimedia Interface) signal;
the switch request is a control signal different from a CEC (Consumer Electronics Control) command; and
the switch controller causes the output switch unit to switch the output destination of the video signal in response to the control signal.

3. The video transmission apparatus according to claim 2, wherein the switch controller controls the output switch unit to switch the output destination of the video signal to the output terminal when power is turned OFF at the output destination of the video signal wirelessly transmitted by the wireless transmission unit or when the video signal input to the input terminal is changed to a non-input state.

4. The video transmission apparatus according to claim 2, wherein the output switch unit outputs the video signal to the output terminal or the wireless transmission unit without canceling HDCP (High-bandwidth Digital Content Protection) performed on the HDMI signal.

5. A video transmission apparatus comprising:
an input terminal input with a video signal;
an output terminal wire connected to a video device;
a wireless transmission unit for modulating the video signal through a predetermined wireless modulation method and wirelessly transmitting the modulated video signal;
an output switch unit, connected with the input terminal, the output terminal, and the wireless transmission unit, for switching an output destination of the video signal input from the input terminal to the output terminal or the wireless transmission unit; and
a switch controller for causing the output switch unit to switch the output destination of the video signal and causing the wireless transmission unit to transmit a switch notification notifying the switching of the output destination.

6. A switch control method of an output destination by a video transmission apparatus including,
an input terminal input with a video signal,
an output terminal wire connected to a video device,
a wireless transmission unit for modulating the video signal through a predetermined wireless modulation method and wirelessly transmitting the modulated video signal, and
an output switch unit, connected with the input terminal, the output terminal, and the wireless transmission unit, for switching an output destination of the video signal input from the input terminal to the output terminal or the wireless transmission unit; the method comprising the step of:
causing the output switch unit to switch the output destination of the video signal in response to a switch request when receiving the switch request of the output destination by the wireless communication unit from a transmitting destination of the video signal.

7. A switch control method of an output destination by a video transmission apparatus including,
an input terminal input with a video signal,
an output terminal wire connected to a video device,
a wireless transmission unit for modulating the video signal through a predetermined wireless modulation method and wirelessly transmitting the modulated video signal, and
an output switch unit, connected with the input terminal, the output terminal, and the wireless transmission unit, for switching an output destination of the video signal input from the input terminal to the output terminal or the wireless transmission unit, the method comprising the step of:
causing the output switch unit to switch the output destination of the video signal and causing the wireless transmission unit to transmit a switch notification notifying the switching of the output destination.
